(19) United States
(12) Patent Application Publication
(10) Pub. No.: US 2005/0212870 A1
(43) Pub. Date: Sep. 29, 2005

(54) Replaceable electrostatically sprayable material reservoir design having electrostatic spraying and method for using same

(76) Inventors: DahShiarn Chiao, Albertson, NY (US); Chien-An Chang, Taipei (TW)

Correspondence Address: DahShiarn Chiao, 11 Wood Avenue, Albertson, NY, 11507, US

(21) Appl. No.: 11/021,045

(22) Filed: Dec. 27, 2004

Related U.S. Application Data
(63) Continuation-in-part of application No. 10/817,402, filed on Mar. 29, 2004.

(51) Int. Cl. B41J 2/085

(52) U.S. Cl. 347/76

(57) ABSTRACT

The present invention concerns a replaceable reservoirs or cartridges system for use with electrostatic or electrohydrodynamic (EHD) spraying device for use in spraying personal care and personal hygiene products. The electrostatic spraying device comprises at least one nozzle for electrostatically charged spray, an associated replaceable reservoir or cartridge for storing at least one electrostatically sprayable material, a special arranged grounding configuration for conducting away cumulated electrostatic field away from the spraying nozzles region and sprayed target, and a nozzle-ring configuration for generating the potential gradient electric field in the vicinity of the nozzles to such an extent that spraying is focused when the forward extremity of the nozzle-ring configuration is brought within a predetermine distance from an earthed target to be sprayed. The replaceable reservoirs or cartridges system contains various electrostatically sprayable means for use by an associated electrostatic spraying device. The electrostatic spraying device is designed to be a portable, hand-held, self-contained, battery or adaptor operated electrostatic personal care and personal hygiene products releasing, with a replaceable reservoirs or cartridges system. Additional embodiments of the present invention comprise nozzle-ring configuration, adjustable nozzle configuration, compressible configuration, one controllable material conducting gate configuration and methods for effectively and efficiently releasing personal care and personal hygiene products stored in replaceable reservoirs or cartridges system.

### CROSS REFERENCE TO RELATED APPLICATION

This application is a continuation-in-part of a prior U.S. application with Ser. No. 10/817,402, filed on Mar. 29, 2004 and entitled “REPLACEABLE ELECTROSTATICALLY SPRAYABLE MATERIAL RESERVOIR FOR USE WITH A ELECTROSTATIC SPRAYING DEVICE”, which is hereby incorporated by reference in its entirety as if filly restated herein.

### FIELD OF THE INVENTION

The present invention concerns a replaceable reservoirs or cartridges system for use in conjunction with an electrostatic or electrohydrodynamic (EHD) spraying device having electrostatic spraying capability, and in particular to a new replaceable reservoirs or cartridges system for use with a hand-held or miniature electrostatic spraying device.

### BACKGROUND OF THE INVENTION

The present invention concerns a replaceable reservoirs or cartridges system and electrostatic or EHD spraying device with special grounding feature that are used to apply hyperdermal cosmetics or medication in, e.g., personal care and personal hygiene products simultaneously. The replaceable reservoirs or cartridges system can be manufactured in a fashion of either replaceable or integrated with electrostatic spraying device. When the replaceable reservoirs or cartridges system and the flow rate adjustable electrostatic spraying device are used in combination with various materials, several electrostatically sprayable materials in different bulk properties (e.g. conductivity, viscosity, surface tension, etc.) may be released within a controllable range of particle size.

The prior art concerning such reservoir and electrostatic spraying device, particularly with reference to those systems intended for use with current and contemplated spraying systems, are best by a number of limitations. In particular, little thought has been given to how a replaceable reservoirs or cartridges system and an electrostatic spraying device can be integrated into a hand-held or miniature device with spraying capability and how to conduct away cumulated electrostatic field or magnetic wave away from the spraying nozzles region and sprayed target through a special arranged grounding or shielding configuration.

### SUMMARY OF THE INVENTION

The limitations of the prior art are overcome in embodiments of the present invention. A first embodiment of the present invention comprises a replaceable reservoirs or cartridges system which having at least one replaceable reservoir or cartridge. Each replaceable reservoir or cartridge further comprises an electrostatically or EHD sprayable material storage region, a replaceable or fixed spraying nozzles region, a material conducting tube region, a nozzle-ring configuration, a controllable material conducting gate configuration and a pumping or force induced compressible configuration. The material storage region comprises a material storage configuration and a compressible configuration. The replaceable spraying nozzles region comprises material conducting channels, a high voltage conducting configuration and various arranged nozzles apparatus. The material conducting tube region comprises a passive feed arrangement and a controllable material conducting gate configuration. The nozzle-ring configuration comprises a conducting or semi-insulating material which surrounds the nozzles and yields the necessary electric field around the nozzles during the initial application of voltage for spraying of the material. In general where the material to be sprayed is in the form of a liquid, the high voltage circuitry will have the effect of causing the propulsion of one or more filaments or ligaments of liquid from the nozzle, which ligament(s) break up into electrostatically charged droplets. Typically the material applied will comprise a cosmetic nature such as personal care products, eg deodorants, antiperspirants, anti-bacterials, perfumes, hair sprays, fresheners, moisturizers and conditioners etc.

A second embodiment of the present invention comprises a specific configuration for a compressible region. The compressible region is constructed with a film or membrane is mounted in fixed relation within the body of the replaceable reservoirs or cartridges and mounted at airtight, typically in a shape of a open-end bag attached to the open-end of the body of the replaceable reservoirs or cartridges, and is usually moved or compressed by air pressure of a pumping action or mechanical force of a motor action. In one variant of the second embodiment, the compressible region is constructed with a piston or valve configuration in an airtight relation within the body of the replaceable reservoirs or cartridges, and is usually moved or opened by air pressure of a pumping action or mechanical force of a motor action. In yet another variant of the second embodiment, the compressible region is constructed with a compressible or bendable tube or bag is attached to or constructed as part of the body of the reservoirs or cartridges and mounted at airtight, typically in a shape of a open-end bag or tube attached to the open-end of the body of the replaceable spraying nozzles region, and is usually squeezed from the very end of the reservoirs or cartridges by a motor-generated rotation or rolling action.

The replaceable reservoir of the second embodiment comprises at least one material storage region, at least one compressible region and at least one spraying nozzles region. The material pumping or compressing means comprises an actuating means for priming material through material conducting tube region during the electrostatic spraying operations to improve the flow of material from the material storage region to the spraying nozzles region. The actuating means comprises a cranking or an electromagnetic activation region having air conduct channel or a mechanical link to the compressible region which generate air pressure or mechanical force to the compressible region in order to facilitate the delivery of the electrostatically sprayable material from the material storage region to the spraying nozzles region. The material conducting tube region and the material storage region provide sufficient air pressure to equalize with the air pressure over the opening of the actuating means after the pumping or compressing operations, and thereby prevents material from returning back to the material storage region.

In another variant of the method of the first preferred embodiment, the adjustable force or pressure generated by the pumping or compressing action is controlled through a gyroscope or inclinometer, and material in electrostatically sprayable form may be released from the spraying nozzles region in different flow rate with the aid of a adjustable force or pressure generated by the pumping or compressing action when the device is holding in different angle or position against the ground or horizon.

A third embodiment of the present invention comprises a controllable material conducting gate configuration. The controllable material conducting gate configuration typically constructed with a film or membrane is mounted in fixed relation to both the spraying nozzles region and material storage region in a airtight fashion, and material in electrostatically sprayable form may be released from the material storage region to the spraying nozzles region when the material conducting gate region is opened. The controllable material conducting gate region may however be opened through a penetrating action, usually in a way of stabbing or screwing a pin or rod through the material conducting gate region, in adjustable relation to the axis of the top of the replaceable reservoirs or cartridges. With a design of the controllable material conducting gate configuration, a replaceable electrostatically sprayable material reservoir or cartridge can prevent further precipitation or clogging of the sprayable material within the nozzles during shipping or storage. In one variant of the third embodiment, the controllable material conducting gate or seal configuration typically constructed with a film or membrane is mounted in fixed relation to the material storage region in a sealed fashion, and material in electrostatically sprayable form may be released from the material storage region to the spraying nozzles region after both the material conducting gate region is opened or removed (e.g. by removing seal, penetrating seal, etc.) and the replaceable spraying nozzles region is attached to the material storage region.

A fourth embodiment of the present invention comprises a specific structure for a nozzle-ring configuration. The specific structure comprises a physical configuration mounted in fixed relation to the body of the device and the ring configuration is in the form of an annular cable mounted on the body of device, and usually in substantially concentric relation with the spraying nozzles unit. The ring configuration and the spraying nozzles unit may however be adjustable with respect to one another in the direction of spraying. Where the nozzles and/or the ring configuration is adjustable, preferably the limits of adjustment are such that the nozzle-ring configuration, over substantially its full range of adjustment, has its forward extremity located forwardly of the nozzles. The arrangement is conveniently such that, in all positions of relative adjustment, spraying is focused when the forward extremity of the nozzle-ring configuration is within a certain distance from an earthed target. In addition, the ring configuration surrounds the nozzles and yields the necessary electric field around the nozzles during the initial application of voltage for spraying of the material thus spraying is focused and also generating iontophoresis effect to enhance sprayed material transport through the skin until the forward extremity of the nozzle-ring configuration is within a certain distance from a human skin target or an earthed target. In an alternative embodiment, the nozzle-ring configuration may be composed of a semi-insulating material which is coupled to a source of high voltage forming part of the device and has sufficient conductivity to permit a potential to be established at a location forwardly of the nozzles which is of the same polarity as that applied to the material emerging at the nozzle.

A fifth embodiment of the present invention comprises a hand-held electrostatic spraying device which having at least one replaceable reservoir or cartridge, at least one replaceable spraying nozzles configuration, a ring configuration, a grounding configuration, a high voltage generator, a power source, a external grounding wire configuration, a control circuit, a grounding circuit design, a trigger, a pumping means and terminals connected to the high voltage generator. The special arranged grounding configuration is directly connected with an external grounding wire configuration through the grounding circuit design. Through the special arranged grounding configuration the cumulated electrostatic field generating by the high voltage circuit forms in the vicinity of the spraying nozzles region is conducted away from the spraying nozzles region and the sprayed target. In one variant of the fifth embodiment, the special arranged grounding configuration is directly connected with an external grounding wire configuration and a special AC to DC adaptor through the grounding circuit design. Through the special arranged grounding configuration the cumulated electrostatic field generating by the high voltage circuit forms in the vicinity of the spraying nozzles region is conducted away from the spraying nozzles region and the sprayed target, and then released into a ground or an AC power source through the special AC to DC adaptor. The grounding circuit design of the special AC to DC adaptor is composed of a capacitor (e.g. Y or X type capacitor) which is directly coupling the secondary core to the primary core of a power transformer within a double blade (AC plug) power adaptor (AC to DC adaptor) so that, in use, the cumulated electrostatic charge/field issuing from the spraying nozzles in a direction away from said spraying nozzles is conducted away from the spraying nozzles region and the sprayed target through the capacitor, secondary core of a power transformer, and primary core of a power transformer then into the grounding of a AC jack or a power source. In yet another variant of the fifth embodiment, a special arranged shielding configuration is directly connected with an external grounding wire configuration and a special AC to DC adaptor through the grounding circuit design. Through the special arranged shielding configuration the generated magnetic wave is conducted into the ground, said spray having a high voltage and a polarity and wherein a magnetic wave forms in the vicinity of the nozzles during use.

### BRIEF DESCRIPTION OF THE FIGURES

The above and other objects and advantages of this invention will be apparent upon consideration of the following detailed description, taken in conjunction with the accompanying drawings in which like characters refer to like elements throughout and in which:

FIG. 1 depicts front, rear and perspective views of a hand-held electrostatic or EHD spraying device and replaceable reservoirs or cartridge made in accordance with a preferred embodiment of the present invention;

FIG. 2 depicts top and cross-sectional views of a replaceable reservoir or cartridge made in accordance with a preferred embodiment of the present invention;

FIG. 3 depicts top and cross-sectional views of a replaceable reservoir or cartridge made in accordance with a preferred embodiment of the present invention;

FIG. 3A depicts top and cross-sectional views of alternate replaceable reservoir or cartridge made in accordance with a preferred embodiment of the present invention;

FIG. 3B depicts top and cross-sectional views of alternate replaceable reservoir or cartridge made in accordance with a preferred embodiment of the present invention;

FIG. 3C depicts top and cross-sectional views of alternate replaceable reservoir or cartridge made in accordance with a preferred embodiment of the present invention;

FIG. 4 depicts front, top and perspective views of a hand-held electrostatic spraying device and replaceable reservoirs or cartridge made in accordance with a preferred embodiment of the present invention;

FIG. 5 depicts top and cross-sectional views of a replaceable reservoir or cartridge made in accordance with a preferred embodiment of the present invention;

FIG. 6 depicts top and cross-sectional views of a replaceable reservoir or cartridge made in accordance with a preferred embodiment of the present invention;

FIG. 6A depicts top and cross-sectional views of alternate replaceable reservoir or cartridge made in accordance with a preferred embodiment of the present invention;

FIG. 6B depicts top and cross-sectional views of alternate replaceable reservoir or cartridge made in accordance with a preferred embodiment of the present invention;

FIG. 7 depicts top and cross-sectional views of a replaceable reservoir or cartridge made in accordance with a preferred embodiment of the present invention;

FIG. 8 depict front, rear and cross-sectional view of a hand-held electrostatic spraying device having at least one replaceable reservoir or cartridge, at least one replaceable spraying nozzles region, a ring configuration, a high voltage generator, a power source, control circuit, trigger and terminals connected to a high voltage generator made in accordance with a preferred embodiment of the present invention;

FIG. 9 depict front, rear and cross-sectional view of a hand-held electrostatic spraying device having at least one alternate replaceable reservoir or cartridge, at least one replaceable spraying nozzles region, a ring configuration, a high voltage generator, a power source, control circuit, trigger and terminals connected to a high voltage generator made in accordance with a preferred embodiment of the present invention;

FIG. 10 depict front, rear and cross-sectional view of a hand-held electrostatic spraying device having at least one replaceable reservoir or cartridge, at least one replaceable spraying nozzles region, a ring configuration, a grounding configuration, a external grounding wire configuration, a high voltage generator, a power source, control circuit, trigger and terminals connected to a high voltage generator made in accordance with a preferred embodiment of the present invention;

FIG. 11 depict front, rear and cross-sectional view of a alternate hand-held electrostatic spraying device having at least one replaceable reservoir or cartridge, at least one replaceable spraying nozzles region, a ring configuration, a grounding configuration, a special AC to DC adaptor, a external grounding wire configuration, a high voltage generator, a power source, control circuit, trigger and terminals connected to a high voltage generator made in accordance with a preferred embodiment of the present invention;

FIG. 12 depict front, rear and cross-sectional view of a hand-held electrostatic spraying device having at least one replaceable reservoir or cartridge, at least one ring configuration, a grounding configuration, a external grounding wire configuration, and a trigger made in accordance with a preferred embodiment of the present invention;

FIG. 13 depict front, rear and cross-sectional view of a alternate hand-held electrostatic spraying device having at least one replaceable reservoir or cartridge, at least one replaceable spraying nozzles region, a ring configuration, a shielding configuration, a external grounding wire configuration, a high voltage generator, a power source, control circuit, trigger and terminals connected to a high voltage generator made in accordance with a preferred embodiment of the present invention;

FIG. 14 depict front, rear and cross-sectional view of an alternate hand-held electrostatic spraying device having at least one replaceable reservoir or cartridge, at least one replaceable spraying nozzles region, a ring configuration, a shielding configuration, a special AC to DC adaptor, a external grounding wire configuration, a high voltage generator, a power source, control circuit, trigger and terminals connected to a high voltage generator made in accordance with a preferred embodiment of the present invention; and

FIG. 15 depict front, rear and cross-sectional view of an alternate hand-held electrostatic spraying device having at least one replaceable reservoir or cartridge, at least one ring configuration, a shielding configuration, a external grounding wire configuration, and a trigger made in accordance with a preferred embodiment of the present invention.

### DETAILED DESCRIPTION OF THE PREFERRED EMBODIMENTS

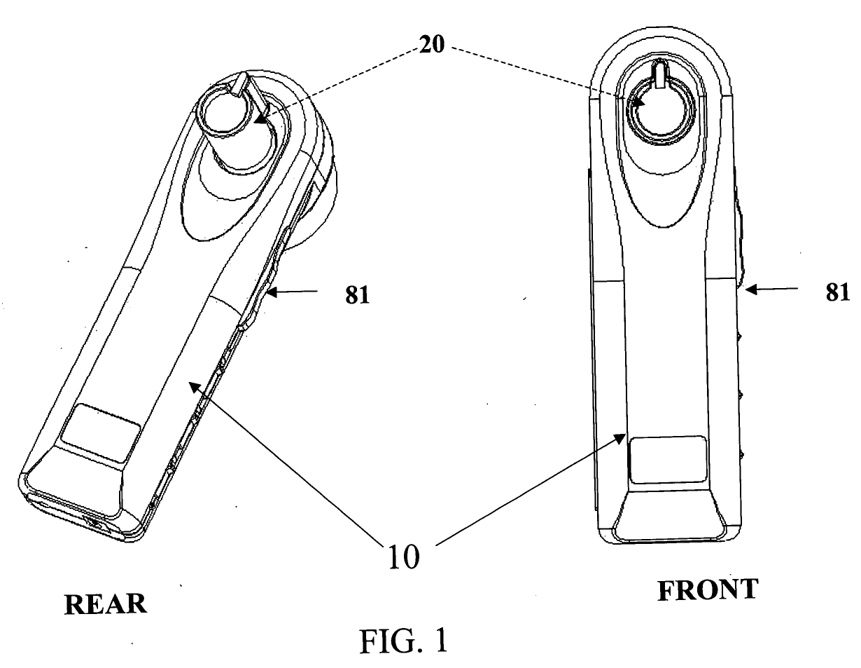

A hand-held electrostatic spraying device made in accordance with the first preferred embodiments of the present invention is depicted in perspective, front and rear views in FIG. 1. The hand-held electrostatic or EHD spraying device 10 integrated replaceable reservoir or cartridge 20 is depicted attached to a hand-held electrostatic spraying device 10.

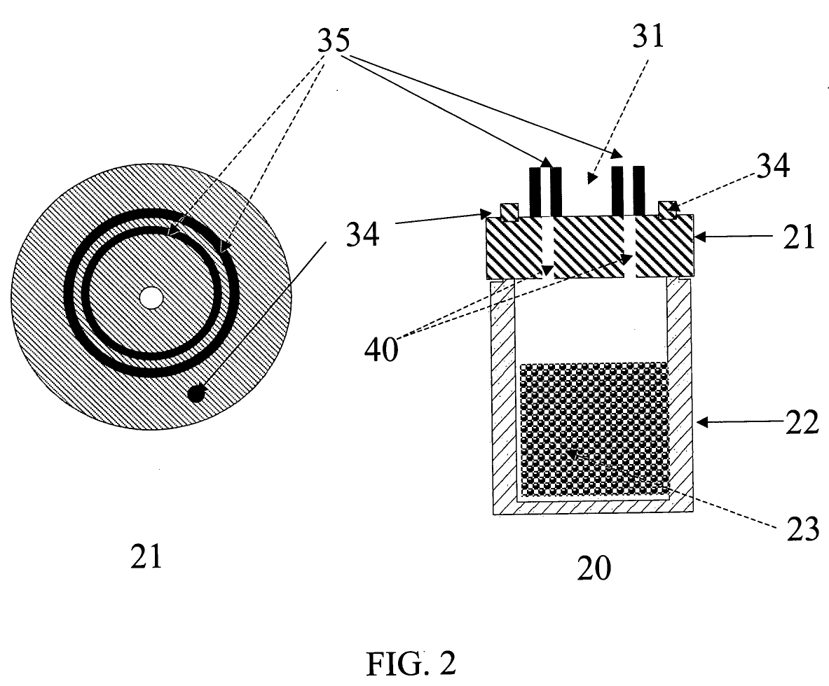

A replaceable reservoir or cartridge made in accordance with the first preferred embodiments of the present invention is depicted in top and cross-sectional views in FIG. 2. The replaceable reservoir or cartridge 20 shown in FIG. 2 comprises an electrostatically sprayable material storage region 22, each of which is contained in a three-dimensional sector of the replaceable reservoir or cartridge 20. The replaceable reservoir or cartridge 20 has a material conducting tube region 40 that is continuously in directly connect with the spraying nozzles region 31. The adjustable nozzle configuration 35 is in the form of two annular tubing mounted on the top of the reservoir body 20 in substantially concentric relation with each other, and usually in fixed relation to, the ring configuration 50. Within the adjustable nozzle configuration 35 and either nozzle tubing may however be regulated with respect to one another in adjusting the gauge of the opening of the adjustable nozzle configuration 35 for spraying. Delivery of an electric charge through a selected terminal 34 to a designated spraying nozzles 30 sublimates the electrostatically sprayable material into many droplets which are focused when the forward extremity of the nozzle-ring configuration 51 is brought within a predetermine distance from an earthed target to be sprayed.

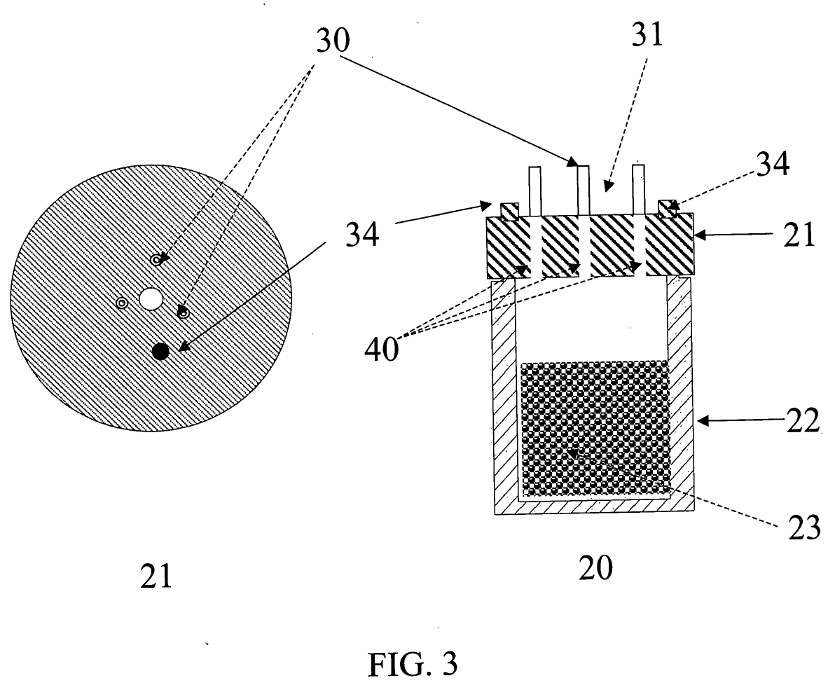

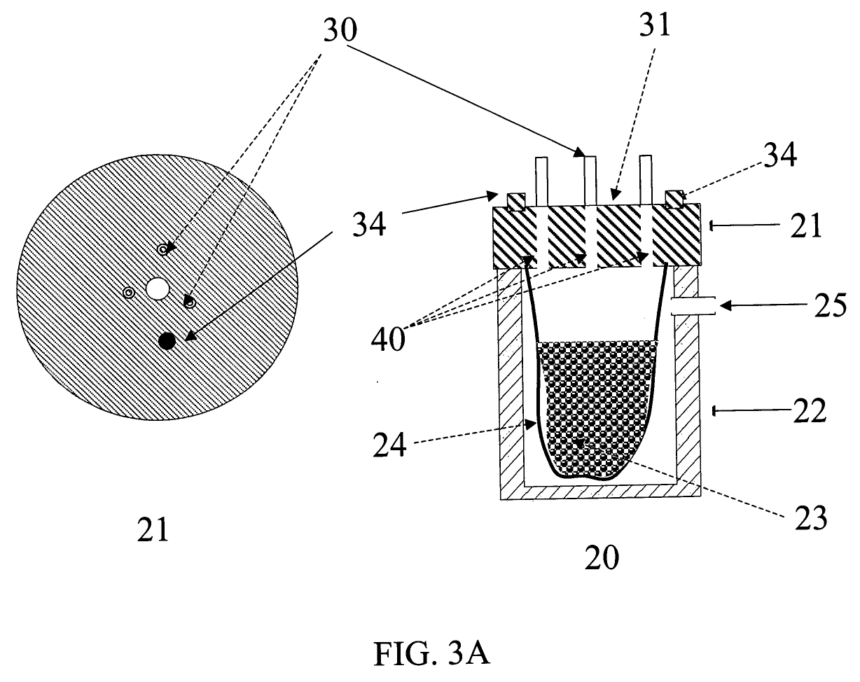

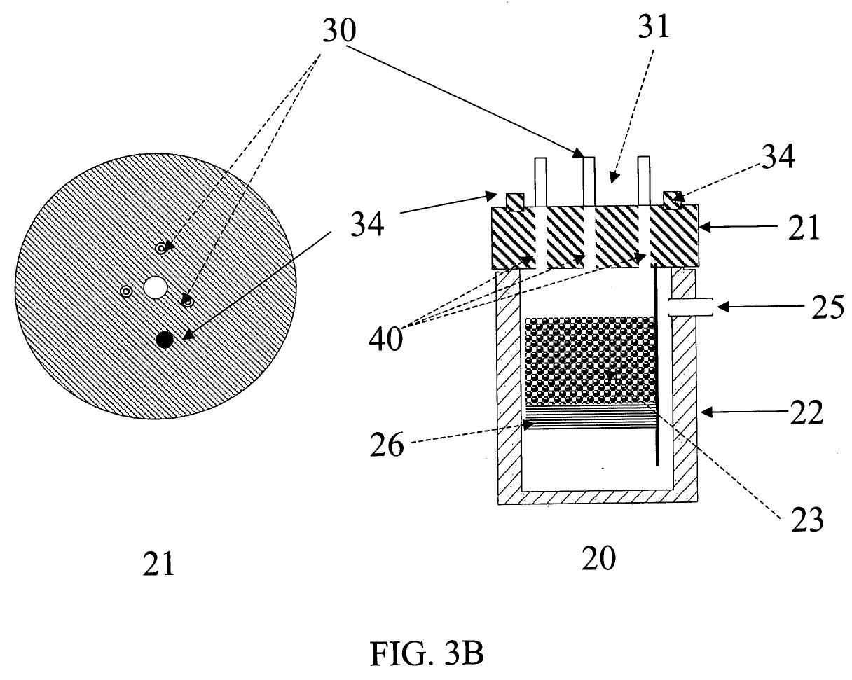

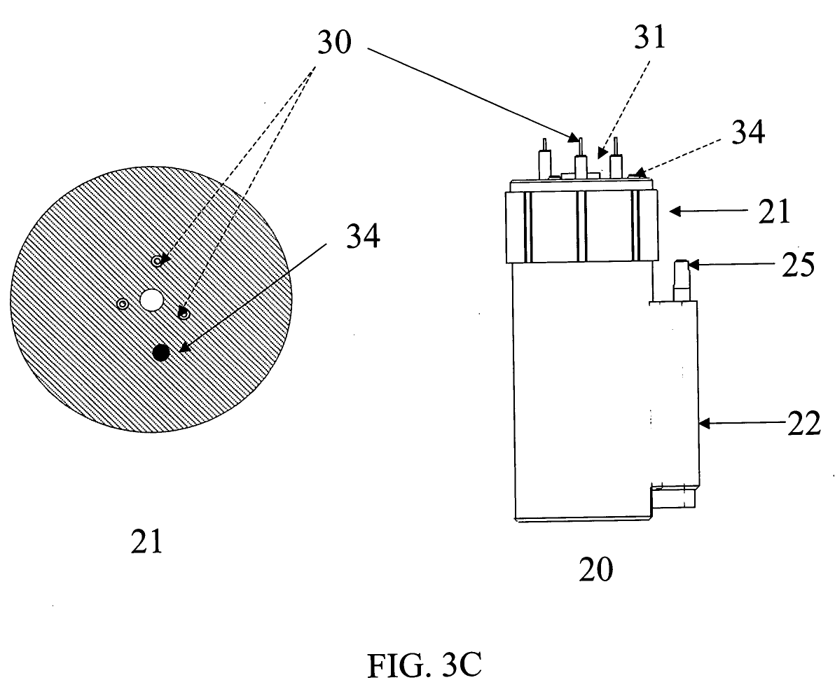

A replaceable reservoir or cartridge made in accordance with the first preferred embodiments of the present invention is depicted in top and cross-sectional views in FIG. 3. The replaceable reservoir or cartridge 20 shown in FIG. 3 comprises an electrostatically sprayable material storage region 22, each of which is contained in a three-dimensional sector of the replaceable reservoir or cartridge 20. The replaceable reservoir or cartridge 20 has a material conducting tube region 40 that is continuously in directly connect with the spraying nozzles region 31. Delivery of an electric charge through a selected terminal 34 to a designated spraying nozzles 30 sublimates the electrostatically sprayable material into many droplets which are focused when the forward extremity of the nozzle-ring configuration 51 is brought within a predetermine distance from an earthed target to be sprayed.

In one alternative embodiment shown in FIG. 3A, a replaceable reservoir or cartridge 20 comprises an electrostatically sprayable material storage region 22, which is contained in a three-dimensional sector of the replaceable reservoir or cartridge 20. The replaceable reservoir or cartridge 20 has a material conducting tube region 40 and an air conduct channel configuration 25 that is continuously in directly connect with the pumping air conduct channel configuration 71 in which air pressure from the pumping means 70 is produced in response to operation of actuating means by the user. The membrane 24 installed in a relation within the replaceable reservoir 20 is compressed when the air pressure is applied. The compressed membrane 24 then push electrostatically sprayable material 23 through the material conducting tube region 40 to the spraying nozzles region 31.

FIG. 3B depicts variants of the second preferred embodiment in which the piston configuration 26 is installed in a relation within the replaceable reservoir 20.

FIG. 3C depicts variants of the second preferred embodiment in which the air conduct channel 25 is constructed in a relation to the replaceable reservoir 20.

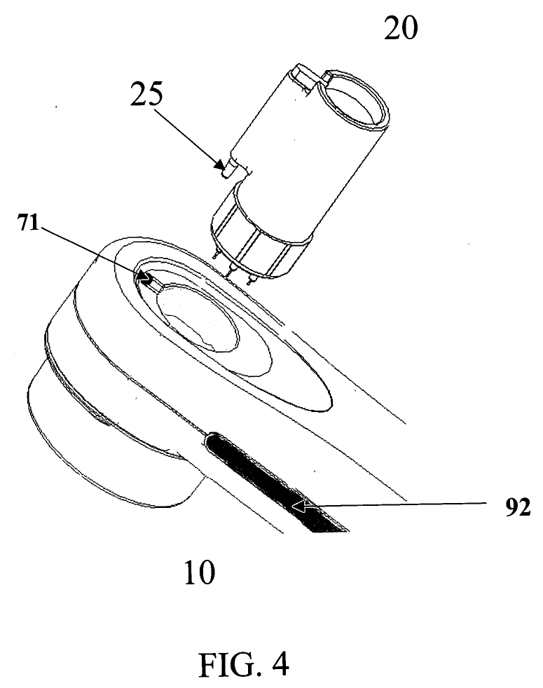

A hand-held electrostatic spraying device made in accordance with the second preferred embodiments of the present invention is depicted in perspective, top and front views in FIG. 4. The hand-held electrostatic spraying device 10 integrated replaceable reservoirs or cartridges 20 is depicted attaching to a hand-held electrostatic spraying device 10.

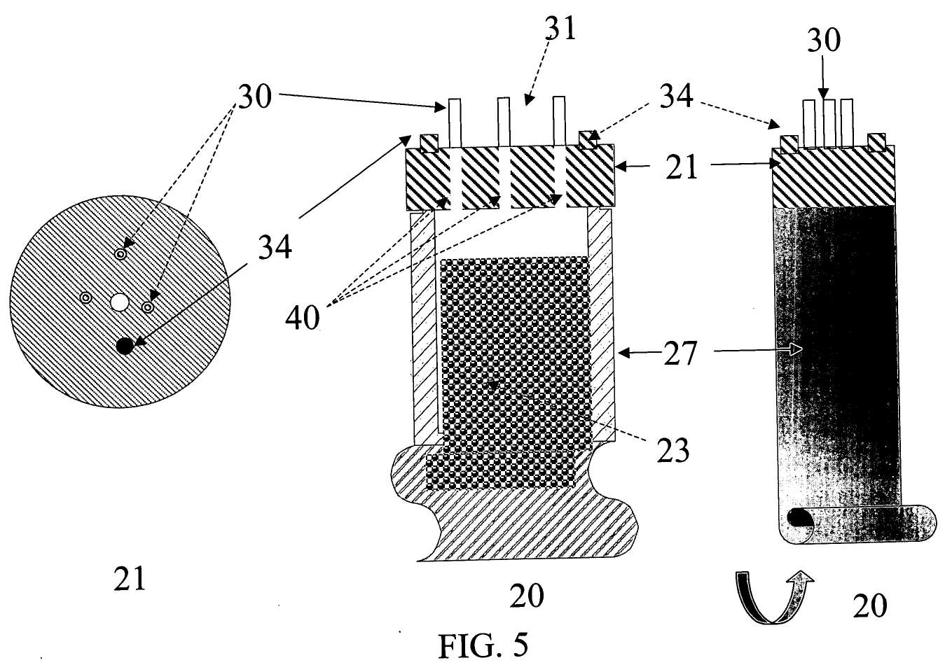

In another alternative embodiment shown in FIG. 5, a replaceable reservoir or cartridge 20 comprises a compressible or bendable electrostatically sprayable material storage region 27, which is constructed in a three-dimensional sector of the replaceable reservoir or cartridge. The replaceable reservoir or cartridge 20 has a material conducting tube region 40 and a compressible or bendable electrostatically sprayable material storage region 27 that is continuously in directly connect with the rolling means 73 or the compressing means 74 in which a mechanical generated force from the rolling means 73 or the compressing means 74 is produced in response to operation of actuating means by the user. The compressible or bendable electrostatically sprayable material storage region 27 connected in a relation with the top of the replaceable reservoir 21 is compressed when the mechanical generated force is applied. The compressed material storage region 27 then force electrostatically sprayable material 23 through the material conducting tube region 40 to the spraying nozzles region 31.

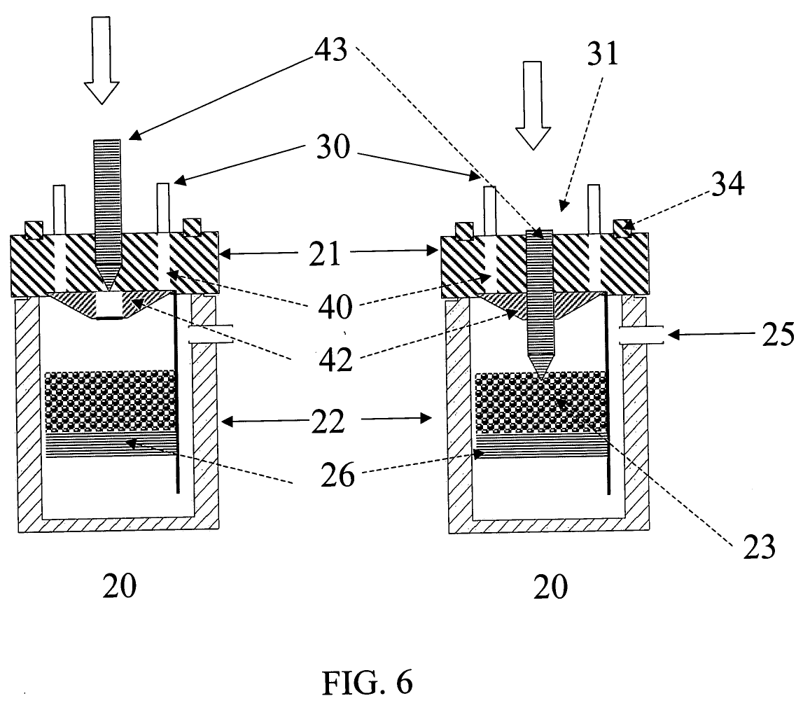

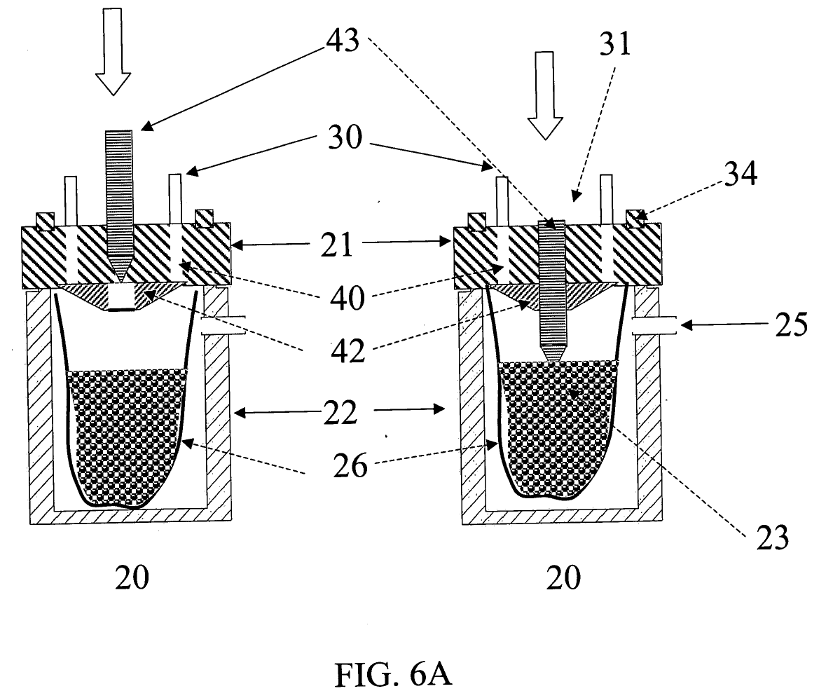

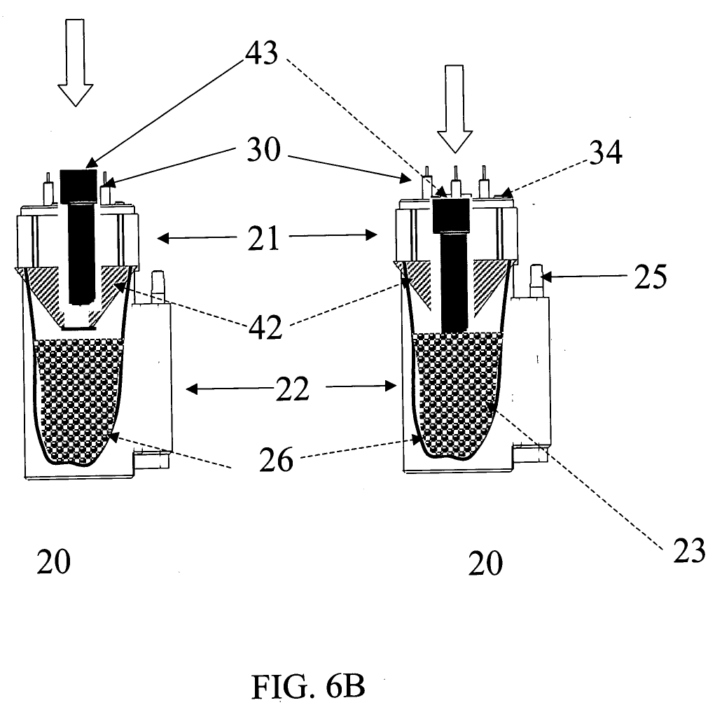

In another alternative embodiment of the present invention shown in FIGS. 6, 6A and 6B, a replaceable reservoir or cartridge 20 comprises a controllable material conducting gate region 42, which is contained in a three-dimensional sector of the replaceable reservoir or cartridge. The replaceable reservoir or cartridge 20 has a material conducting tube region 40 and a controllable material conducting gate region 42 that is closed and block the connection between the material conducting tube region 40 and the electrostatically sprayable material storage region 22. The gate configuration 42 installed in a relation within the replaceable reservoir 20 is opened when the pin 43 is applied to penetrate the gate region 42. Electrostatically sprayable material 23 released from the material storage region 22 through the material conducting tube region 40 to the spraying nozzles region 31.

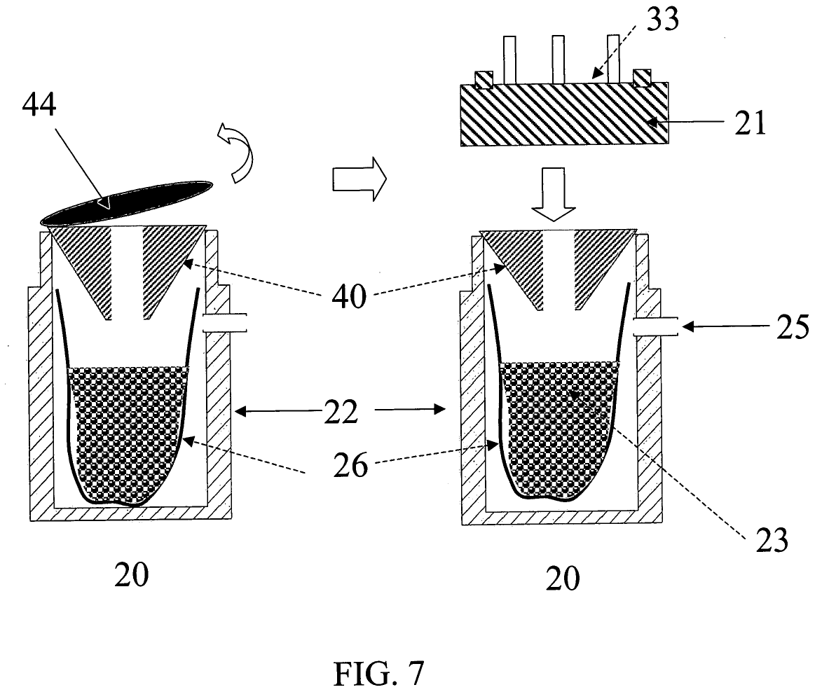

In yet other embodiment of the present invention shown in FIG. 7, a replaceable reservoir or cartridge 20 comprises a replaceable spraying nozzles configuration 33, which is installed in a relation to the top of the replaceable reservoir or cartridge. The replaceable reservoir or cartridge 20 has a replaceable spraying nozzles region 33 and a removable sealing configuration 44 that is sealed and block the connection between the material conducting tube region 40 and the electrostatically sprayable material storage region 22. When the removable sealing configuration 44 installed in a relation within the replaceable reservoir 20 is opened or removed the electrostatically sprayable material 23 released from the material storage region 22 through the material conducting tube region 40 to the spraying nozzles region 31.

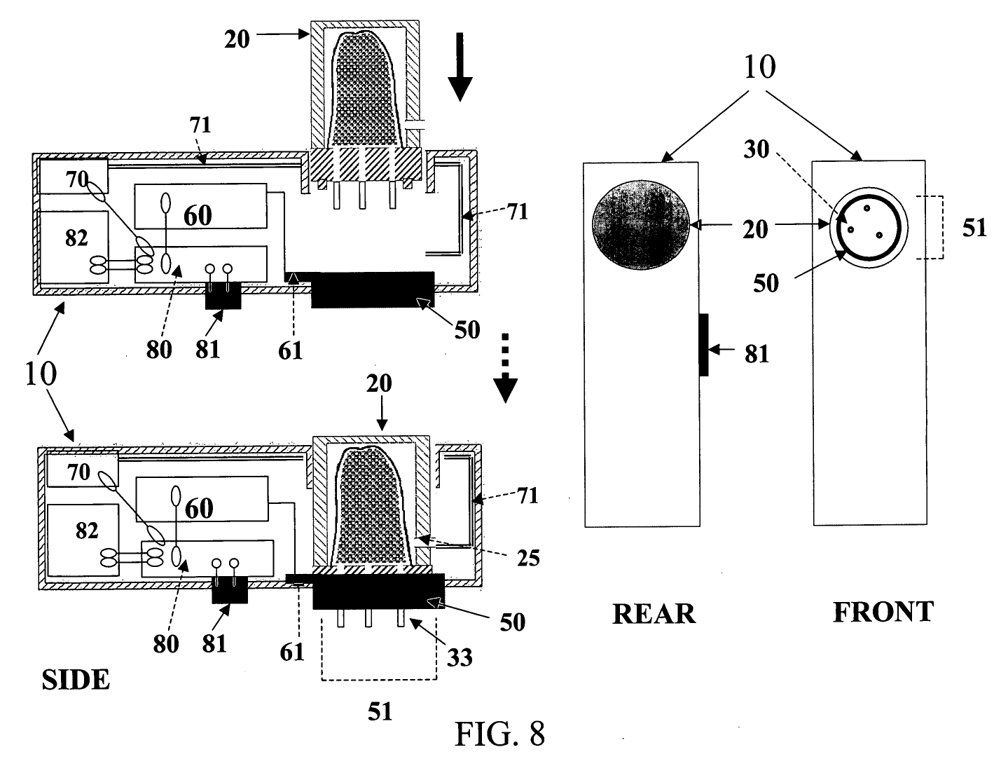

A complete hand-held electrostatic spraying device 10 having replaceable reservoir or cartridge 20, at least one replaceable spraying nozzles configuration 33, a ring configuration 50, a high voltage generator 60, a power source 82, control circuit 80, a trigger 81, a pumping means 70 and terminals 61 connected to the high voltage generator 60 made in accordance with the first preferred embodiment of the present invention is shown in FIG. 8. The replaceable reservoir or cartridge 20 shown in FIG. 8 comprises a sprayable material storage region 22, which is contained in a three-dimensional sector of the replaceable reservoir or cartridge. The hand-held electrostatic spraying device 10 has terminals 61 that directly connect with a high voltage generator 60 and the ring configuration 50. By connecting the ring configuration 50 to a designated terminal 34 from a replaceable reservoir or cartridge 20, delivery of an electric charge through ring configuration 50 and 34 sublimates the electrostatically sprayable material into many droplets which are focused when the forward extremity of the nozzle-ring configuration 50 is brought within a predetermine distance from an earthed target to be sprayed.

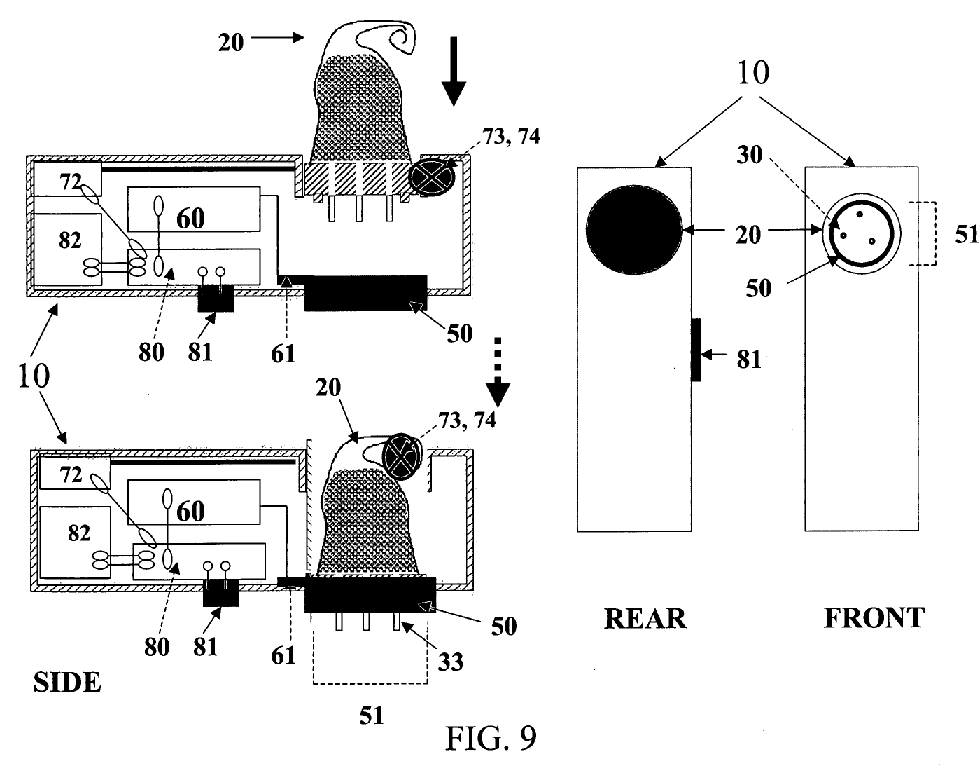

In one alternative embodiment shown in FIG. 9, a hand-held electrostatic spraying device 10 having rolling means 73 or compressing means 74 can be integrated with a replaceable reservoir or cartridge 20 having compressible or bendable electrostatically sprayable material storage region 27 to be applied through a rolling means 73 or compressing means 74 to supply material 23 from the material storage region 22 to the spraying nozzles region 31 for further electrostatic spraying at nozzles.

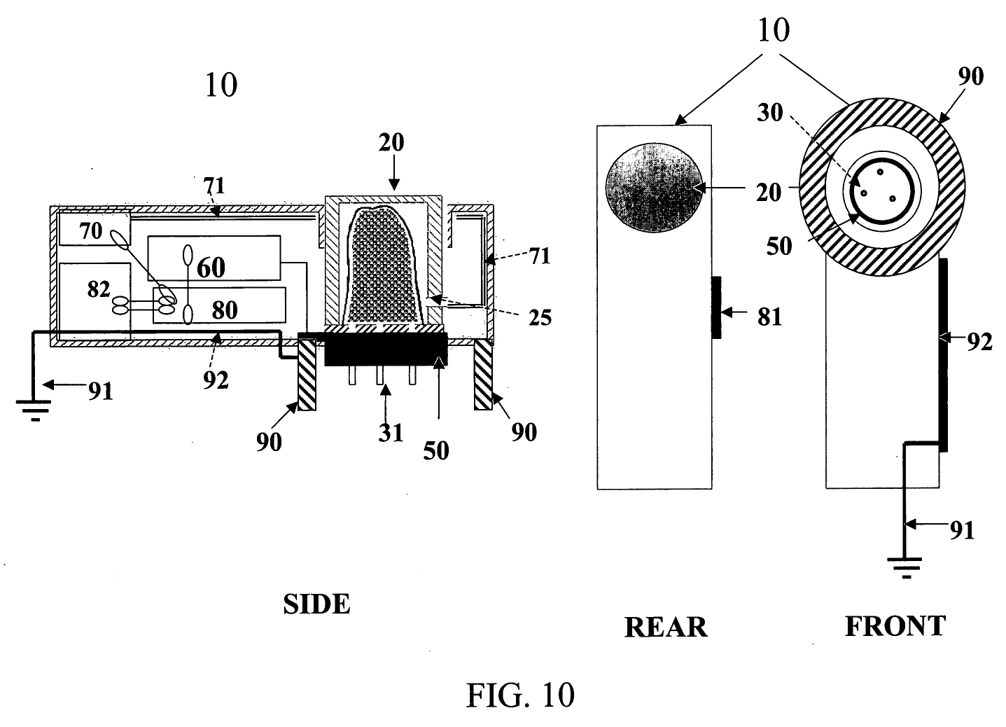

A complete hand-held electrostatic spraying device 10 having replaceable reservoir or cartridge 20, at least one replaceable spraying nozzles configuration 33, a ring configuration 50, a grounding configuration 90, a high voltage generator 60, a power source 82, a external grounding wire configuration 91, control circuit 80, a grounding circuit design 92, a trigger 81, a pumping means 70 and terminals 61 connected to the high voltage generator 60 made in accordance with the fifth preferred embodiment of the present invention is shown in FIG. 10. The replaceable reservoir or cartridge 20 shown in FIG. 10 comprises a sprayable material storage region 22, which is contained in a three-dimensional sector of the replaceable reservoir or cartridge 20. The hand-held electrostatic spraying device 10 has a grounding configuration 90 that directly connect with a external grounding wire configuration 91 through the grounding circuit design 92. The cumulated electrostatic field generating by the high voltage circuit forms in the vicinity of the spraying nozzles region 31 is conducted away from the spraying nozzles region 31.

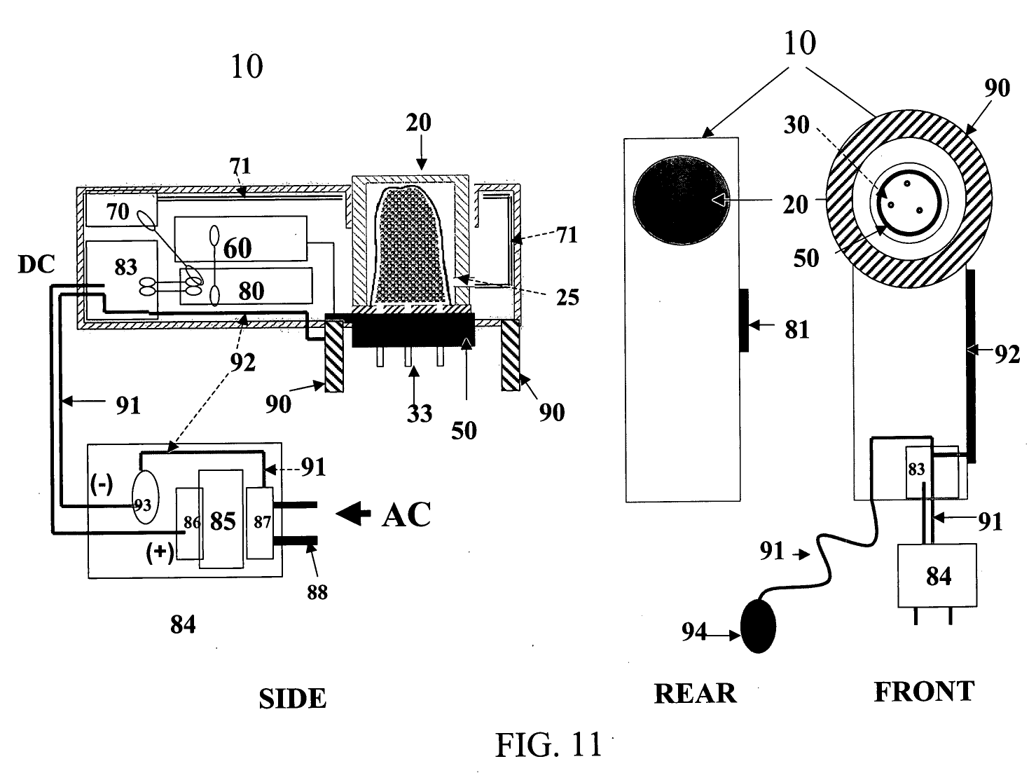

In one alternative embodiment shown in FIG. 11, a complete hand-held electrostatic spraying device 10 having replaceable reservoir or cartridge 20, at least one replaceable spraying nozzles region 33, a ring configuration 50, a grounding configuration 90, a special AC to DC adaptor 84, a high voltage generator 60, a power source 82, a external grounding wire configuration 91, control circuit 80, a grounding circuit design 92, a trigger 81, a pumping means 70 and terminals 61 connected to the high voltage generator 60 made in accordance with the first preferred embodiment of the present invention is shown in FIG. 11. The replaceable reservoir or cartridge 20 shown in FIG. 11 comprises a sprayable material storage region 22, which is contained in a three-dimensional sector of the replaceable reservoir or cartridge 20. The hand-held electrostatic spraying device 10 has a grounding configuration 90 that directly connect with an external grounding wire configuration 91 and a special AC to DC adaptor 84 through the grounding circuit design 92. The cumulated electrostatic field generating by the high voltage circuit forms in the vicinity of the spraying nozzles region 31 is conducted away from the spraying nozzles region 31 and then released into a ground or an AC power source through the special AC to DC adaptor 84.

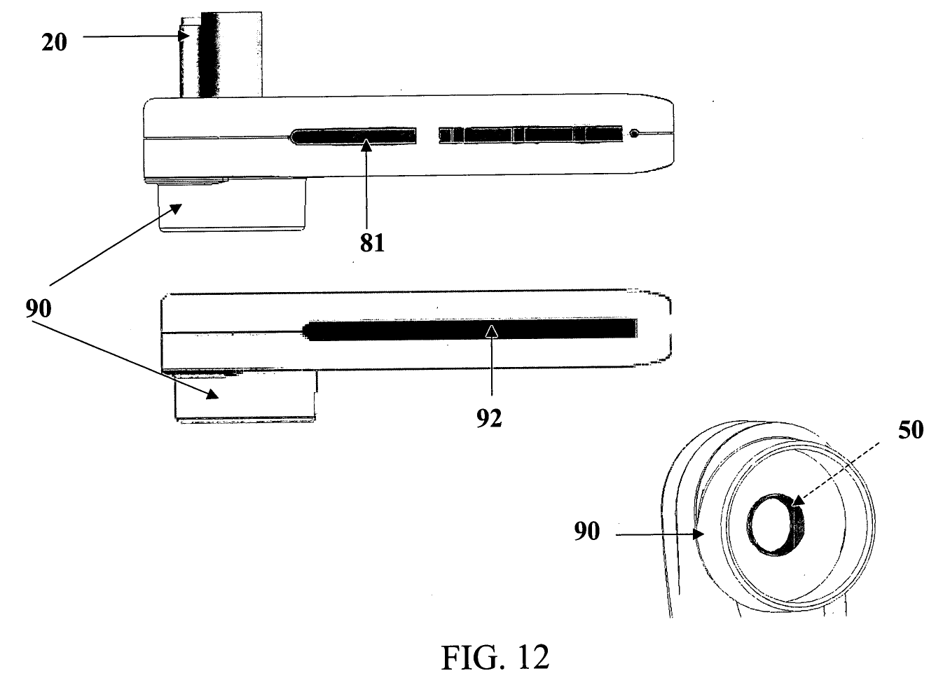

FIG. 12 depicts variants of the fifth preferred embodiment in which the grounding configuration 90 and the grounding circuit design 92 are constructed in a relation to the hand-held electrostatic spraying device 10.

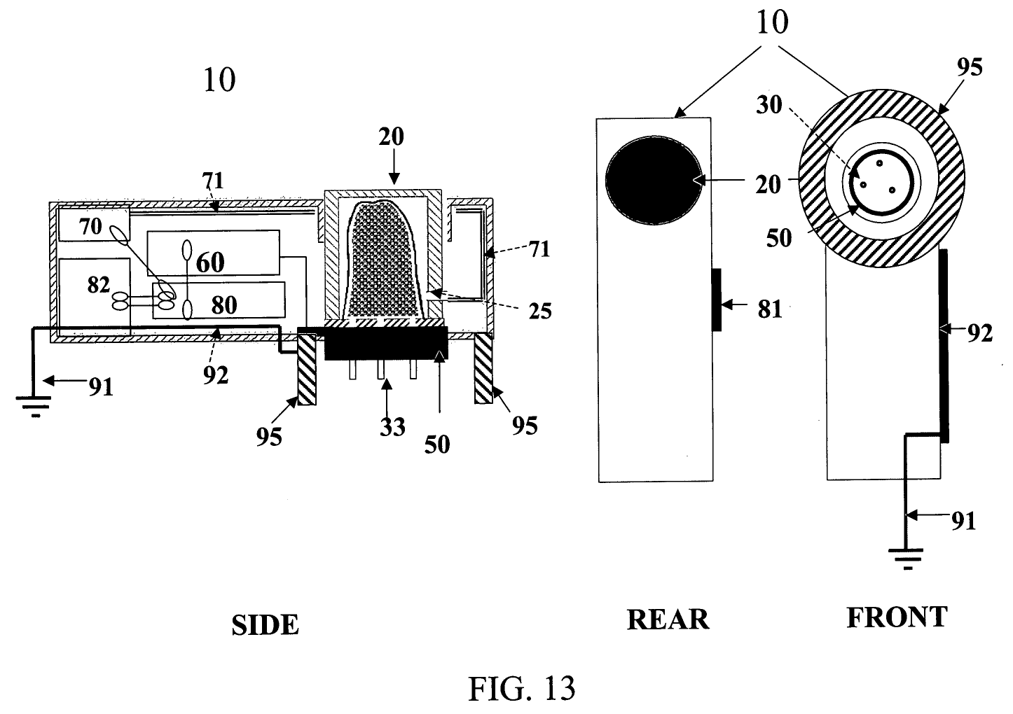

A complete hand-held electrostatic spraying device 10 having replaceable reservoir or cartridge 20, at least one replaceable spraying nozzles region 33, a ring configuration 50, a shielding configuration 95, a high voltage generator 60, a power source 82, a external grounding wire configuration 91, control circuit 80, a grounding circuit design 92, a trigger 81, a pumping means 70 and terminals 61 connected to the high voltage generator 60 made in accordance with the fifth preferred embodiment of the present invention is shown in FIG. 13. The replaceable reservoir or cartridge 20 shown in FIG. 13 comprises a sprayable material storage region 22, which is contained in a three-dimensional sector of the replaceable reservoir or cartridge 20. The hand-held electrostatic spraying device 10 has a shielding configuration 95 that directly connect with a external grounding wire configuration 91 through the grounding circuit design 92. The magnetic wave generating by the high voltage circuit forms in the vicinity of the spraying nozzles region 31 is conducted away from the spraying nozzles region 31.

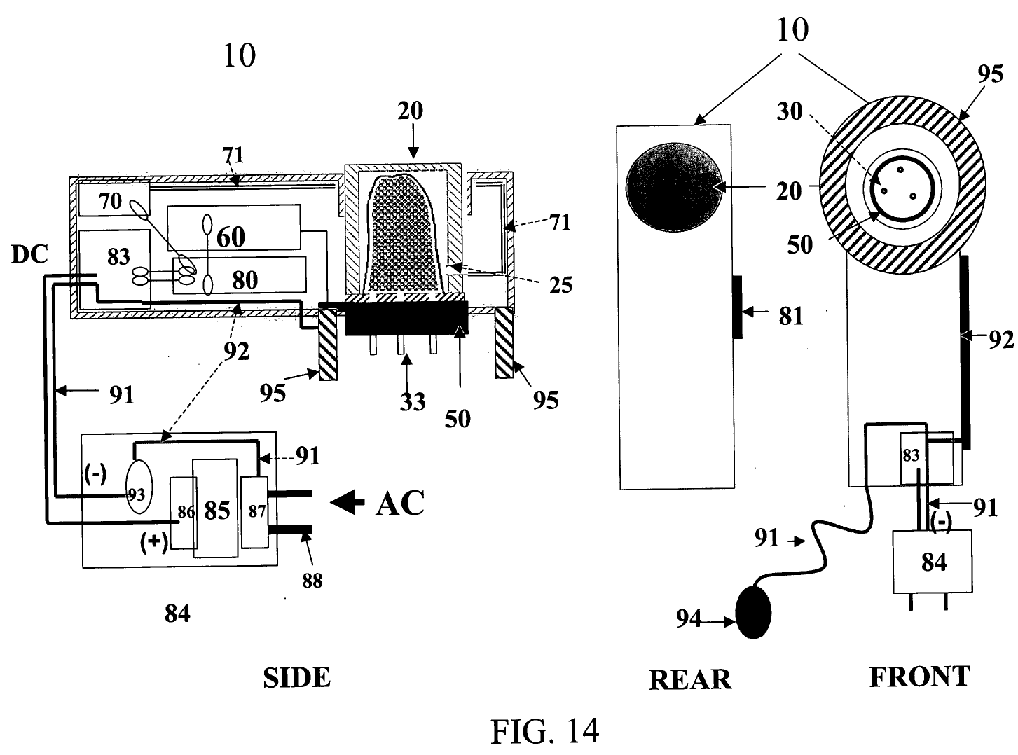

In one alternative embodiment shown in FIG. 14, a complete hand-held electrostatic spraying device 10 having replaceable reservoir or cartridge 20, at least one replaceable spraying nozzles region 33, a ring configuration 50, a shielding configuration 95, a special AC to DC adaptor 84, a high voltage generator 60, a power source 82, a external grounding wire configuration 91, control circuit 80, a grounding circuit design 92, a trigger 81, a pumping means 70 and terminals 61 connected to the high voltage generator 60 made in accordance with the fifth preferred embodiment of the present invention is shown in FIG. 14. The replaceable reservoir or cartridge 20 shown in FIG. 14 comprises a sprayable material storage region 22, which is contained in a three-dimensional sector of the replaceable reservoir or cartridge 20. The hand-held electrostatic spraying device 10 has a shielding configuration 95 that directly connect with an external grounding wire configuration 91 and a special AC to DC adaptor 84 through the grounding circuit design 92. The magnetic wave generating by the high voltage circuit forms in the vicinity of the spraying nozzles region 31 is conducted away from the spraying nozzles region 31 and then released into a ground or an AC power source through the special AC to DC adaptor 84.

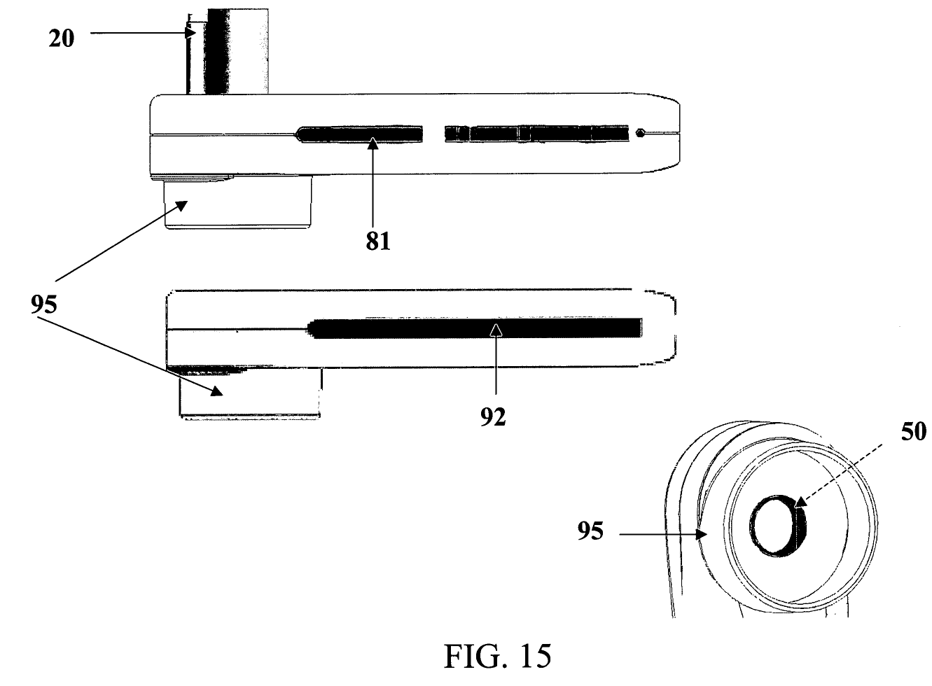

FIG. 15 depicts variants of the fifth preferred embodiment in which the shielding configuration 95 and the grounding circuit design 92 is constructed in a relation to the hand-held electrostatic spraying device 10.

1. A replaceable reservoirs or cartridge for use with electrostatic or EHD spraying device of the type wherein at least one electrostatically sprayable material is contained in a reservoir housing, the electrostatic spraying device comprising high voltage circuitry arranged so that, in use, the material issuing from the spraying nozzles in a direction away from said spraying nozzles forms an electrostatically charged spray, said spray having a high voltage and a polarity and wherein an electric field forms in the vicinity of the nozzles during use, the replaceable reservoirs or cartridges comprising:
at least one electrostatically sprayable material storage configuration;
at least one replaceable or fixed spraying nozzles configuration;
at least one compressible configuration;
at least one controllable material conducting gate configuration connecting the material storage region to the spraying nozzles region, wherein the gate is opened during electrostatic spraying operations material flows from the material storage region to the spraying nozzles region passively or user-inducible; and
at least one connecting port configuration for conducting the high voltage to the nozzle-ring configuration so that spraying from the nozzles is focused when the forward extremity of the nozzle-ring configuration is brought within a predetermine distance from an earthed target to be sprayed;

2. A method as claimed in claim 1 in which the nozzles is mounted in fixed relation to the body of the replaceable reservoirs or cartridges and the ring configuration is mounted in fixed relation to the device body, and the nozzles is in the form of an annular cable mounted in fixed relation to the top of the body of the replaceable reservoirs or cartridges in substantially concentric relation with, and usually in fixed relation to, the ring configuration. The ring configuration and the nozzles configuration may however be adjustable with respect to one another in the direction of spraying, the spraying area and the spraying angle.

3. A method as claimed in claim 1 in which the nozzles is mounted in fixed relation to the body of the replaceable reservoirs or cartridges and the adjustable nozzle configuration is in the form of two annular tubing mounted on the top of the reservoir body in substantially concentric relation with each other, and usually in fixed relation to, the ring configuration. Within the adjustable nozzle configuration and either nozzle tubing may however be regulated with respect to one another in adjusting the gauge of the opening of the adjustable nozzle configuration for spraying.

4. A method as claimed in claim 3 wherein the gauge of the opening of the adjustable nozzle configuration is adjusted in relation to the bulk properties (e.g. conductivity, viscosity, surface tension, etc.) of the solution being sprayed.

5. A method as claimed in claim 3 wherein the opening of the adjustable nozzle configuration is adjusted in a fashion of changing the gauge between two nozzle tubing having various diameter/thickness, usually in a way of rotating or screwing either nozzle tubing in certain direction, in adjustable relation to the axis of the top of the replaceable reservoirs or cartridges.

6. A method as claimed in claim 1 wherein a compressible configuration is constructed with but not limit to a film or membrane which is mounted in fixed relation within the body of the replaceable reservoirs or cartridges and mounted at airtight, typically in a shape of a open-end bag attached to the open-end of the body of the replaceable reservoirs or cartridges, and is usually moved or compressed by air pressure of a pumping action or a mechanical force of a motor action.

7. A device as claimed in claim 1 wherein a piston or valve configuration is mounted in fixed relation within the body of the reservoirs or cartridges and mounted at airtight, and is usually moved or opened by air pressure of a pumping action or a mechanical force of a motor action.

8. A device as claimed in claim 6 and 7 wherein the adjustable force or pressure generated by the pumping action or motor action is controlled through a gyroscope or inclinometer, and material in electrostatically sprayable form may be released from the spraying nozzles region in different speed of flow with the aid of a adjustable force or pressure generated by the pumping action or motor action when the device is holding in different angle or position against the ground or horizon.

9. A device as claimed in claim 1 wherein a compressible or bendable tube or bag is attached to or constructed as part of the body of the reservoirs or cartridges and mounted at airtight, typically in a shape of a open-end bag or tube attached to the open-end of the body of the replaceable spraying nozzles configuration, and is usually squeezed from the very end of the reservoirs or cartridges by a motor-generated rotation or rolling action.

10. A device as claimed in claim 1 wherein the controllable material conducting gate configuration is mounted in fixed relation to both the spraying nozzles configuration and material storage configuration, and material in electrostatically sprayable form may be released from the material storage region to the spraying nozzles region when the gate material conducting region is opened.

11. A device as claimed in claim 10 wherein the controllable material conducting gate configuration is constructed but not limit to as a film or membrane is opened through a penetrating action, usually in a way of stabbing or screwing a pin or rod through the material conducting gate region, in adjustable relation to the axis of the top of the replaceable reservoirs or cartridges.

12. A device as claimed in claim 1 wherein the controllable material conducting gate or seal configuration is mounted in fixed relation to the material storage configuration, and material in electrostatically sprayable form may be released from the material storage region to the spraying nozzles region after both the material conducting gate configuration is opened or removed (e.g. by removing seal, penetrating seal, etc.) and the replaceable spraying nozzles configuration is attached to the material storage configuration.

13. A method as claimed in claim 2 in which the nozzles is mounted in fixed relation to the body of the replaceable reservoirs or cartridges and a ring configuration is mounted in fixed relation to the device body, and the nozzles and ring configuration are composed of a conductive material, a conductive plastic material or coated with conductive material (e.g. metal).

14. An electrostatic spraying device comprising casing housing a high voltage generator, a dispensing nozzles from which an electrostatically sprayable material is sprayed in use wherein when sprayed said spray had a voltage and a polarity, reservoirs or cartridges for containing materials to be sprayed in bulk wherein during use said reservoirs contains bulk material to be sprayed, further comprises:
a pumping means for supplying air or air pressure through a passage leading to the compressible configuration, means coupling the air pressure output of the pump to the piston, film or membrane so that the electrostatically sprayable material is moved through the opened material conducting gate region to the material present at the dispensing nozzles whereby the material issuing from the nozzles under the influence of an applied voltage forms an electrostatically charged spray wherein an electric field forms in the vicinity of the nozzles during use, characterized by the provision of a nozzle-ring configuration on which a voltage of the same polarity as that applied to the material to be sprayed is developed in use, the nozzle-ring configuration being located forwardly of the dispensing nozzles in the direction of spraying and arranged in such a way as to generate the electric field in the vicinity of the nozzles so that spraying from the nozzles is focused to prevent immediate loss of the charged aerosol and prevent spraying from the nozzles.

15. A device as claimed in claim 14 in which the pumping means comprises means for priming or compressing said the material from the reservoir to the nozzle by air pressure of a pumping action or mechanical force of a motor action.

16. A device as claimed in claim 14 in which the pumping means further comprises means for moving or compressing said the material from the reservoir to the nozzle by a motor-generated rotation or rolling action.

17. A device as claimed in claims 14 in which pumping of the material is produced in response to operation of actuating means with a preprogrammed frequency.

18. A device as claimed in claim 17 in which operation of the actuating means is accompanied by justifying with the bulk properties (e.g. conductivity, viscosity, surface tension, etc.) of the solution being sprayed or the flow rate for supplying the material to the spraying nozzles region.

19. A device as claimed in claim 18 wherein the flow rate for supplying the material to the spraying nozzles region through the pumping means is controlled by a gyroscope or inclinometer, and material in electrostatically sprayable form may be released from the material storage region to the spraying nozzles region in different flow rate with the aid of the pumping means when the device is holding in different angle or position against the ground or horizon.

20. An electrostatic spraying device comprising casing housing a high voltage generator, a special arranged grounding configuration and an external grounding wire configuration from which the cumulated electrostatic charge/field is conducted into the ground, said spray having a high voltage and a polarity and wherein an electric field forms in the vicinity of the nozzles during use.

21. A device as claimed in claim 20 in which the electrostatic spraying device comprising special arranged grounding configuration so that, in use, the cumulated electrostatic field generating by the high voltage circuit forms in the vicinity of the spraying nozzles region is conducted away from the spraying nozzles region.

22. A device as claimed in claim 20 in which the electrostatic spraying device comprising an external grounding wire configuration so that, in use, the cumulated electrostatic charge/field issuing from the spraying nozzles in a direction away from said spraying nozzles is conducted away from the sprayed target.

23. A device as claimed in claim 22 in which the external grounding wire configuration comprising a grounding circuit design so that, in use, the cumulated electrostatic charge/field issuing from the spraying nozzles in a direction away from said spraying nozzles is conducted away from the sprayed target.

24. A device as claimed in claim 23 in which the grounding circuit design is composed of a capacitor (e.g. Y or X type capacitor) which is directly coupling the secondary core to the primary core of a power transformer within a double blade (AC plug) power adaptor (AC to DC adaptor) so that, in use, the cumulated electrostatic charge/field issuing from the spraying nozzles in a direction away from said spraying nozzles is conducted away from the spraying nozzles and sprayed target through the capacitor, secondary core of a power transformer, and primary core of a power transformer then into the grounding of a AC jack or a power source.

25. A device as claimed in claim 20 in which the material for external grounding wire configuration is composed of a conductive material which is coupled to the ground or power source, usually in a fashion of metal chains, metal bracelets or conductive pads.

26. An electrostatic spraying device comprising casing housing a high voltage generator, a special arranged shielding configuration and an external grounding wire configuration from which the generated magnetic wave is conducted into the ground, said spray having a high voltage and a polarity and wherein a magnetic wave forms in the vicinity of the nozzles during use.

27. A device as claimed in claim 26 in which the electrostatic spraying device comprising special arranged shielding configuration so that, in use, the magnetic wave generating by the high voltage circuit forms in the vicinity of the spraying nozzles region is conducted away from the spraying nozzles region.

28. A device as claimed in claim 26 in which the electrostatic spraying device comprising special arranged shielding configuration so that, in use, the magnetic wave generating by the arching or ionization forms in the vicinity of the spraying nozzles region is conducted away from the spraying nozzles region.
